(19) United States
(12) Patent Application Publication
(10) Pub. No.: US 2023/0300389 A1
(43) Pub. Date: Sep. 21, 2023

(54) METHODS AND APPARATUS FOR PROCESSING MEDIA CONTENT

(71) Applicant: BRITISH TELECOMMUNICATIONS PUBLIC LIMITED COMPANY, London (GB)

(72) Inventors: Martin TRIMBY, London (GB); Ian KEGEL, London (GB); Douglas WILLIAMS, London (GB)

(21) Appl. No.: 18/016,821

(22) PCT Filed: Jul. 14, 2021
(86) PCT No.: PCT/EP2021/069664

§ 371 Date: Jan. 18, 2023

(30) Foreign Application Priority Data
Jul. 20, 2020 (GB) 2011202.5

(51) Int. Cl. H04N 21/2343; H04N 21/431

(52) U.S. Cl. CPC H04N 21/23439; H04N 21/4312; H04N 21/41407

(57) ABSTRACT

Methods and apparatus are disclosed for processing media content to be rendered as a presentation for a user at a set of one or more media devices (60, 600) in an arrangement at a point in time, the presentation being based on layout rules (66b) defining suitability and configuration of media objects (55) for rendering, the arrangement and one or more user-associated characteristics and/or attributes constituting a context for the presentation which is formed of selected media objects from a set, the context having one or more constraints (66c), each constraint defining a property of the context affecting the rendering of at least a subset of the selected media objects (55). The method comprises configuring, for each media object, a characteristic satisfying a utility condition based on a measure of utility of the media object (55) in the context at the point in time, the measure of utility being evaluated in respect of the constraints (66c) of the context; and identifying the selected media objects from the set based on the measures of utility and layout rules (66b).

### TECHNICAL FIELD

The present invention relates to methods and apparatus for processing media content. It relates in particular to computer-implemented methods for processing media content to be rendered as a presentation for a user at a set of one or more media devices such as televisions, tablets, smart-phones, etc., the media content comprising media objects at least some of which include video content in a technology referred to as “Object-Based Broadcasting”.

### BACKGROUND

Object-Based Broadcasting (OBB) is a term used to describe mechanisms that allow television (TV) programmes and other such presentations of media content to become personalised. In this context, the “objects” are different media components that can be brought together to make up a television programme or other such presentation. These can include video content that is cut together (e.g. to tell a story, show a sporting event, or present information about a topic), music, speech and special effects, video replays and slow motion replays (particularly in relation to sports programmes), subtitles, picture-in-picture inserts, graphics, commentary, an on-screen signer providing interpretation for the deaf, and studio-rendered virtual reality (VR) overlays.

In traditional (i.e. non-OBB) television, the presentation and timing of these media “objects” (i.e. whether, when, where and how they appear on the screen or are heard) is controlled by those making the programme. By not fixing the arrangement of these objects and leaving the viewer with some control over what objects can be accessed and how they are presented, content providers can enable the user's experience of a programme or other such presentation to become personalised.

Makers of television programmes, films etc. have for years had to make some concessions to adapt the scale of their content for presentation on different screens. Some common examples are illustrated in FIG. 1.

FIG. 1(a) shows a 4:3 image shown in a 16:9 screen (where X:Y relates to the ratio of the horizontal to the vertical size or number of pixels). In this instance, “pillars” (shown in black) either side of the 4:3 image fill the remainder of the screen. This is called “pillarboxing”.

The reason for this is more evident from FIG. 1(b), which shows a 4:3 image made up of 12 blocks (horizontally) by 9 blocks (vertically) shown in a 16:9 screen. Pillars having a two-block width are used on each side to fill the screen.

(NB For convenience, Individual blocks within the image in FIG. 1(a) are numbered using a “row:column” identification “m:n” with the top-left block being numbered “1:1” and the bottom-right being numbered “9:12”-this is purely to allow for the numbers of blocks per-row and per-column to be easily reviewed-the numbering system is arbitrary, and will be simplified in later FIGS. 3 and 4 to avoid unnecessarily cluttering these figures and to avoid unnecessarily-small text.)

FIG. 2(a) shows a 21:9 image shown in a 16:9 screen. In this instance, bars above and below the image fill the screen. This is known as “letterboxing”.

While some effort has been made by broadcasters to prepare images for screens of different sizes, television manufacturers also offered users options to adapt images, offering “Fill” or “Zoom” functions which would either stretch the image to fill the whole screen—perhaps with a loss of appropriate aspect ratio within the shot making faces longer or wider than they should be—depending on the aspect ratio of the target screen and the source content.

Such options can thus offer alternatives to pillars and letterboxes. FIG. 3 illustrates the effect of using an option involving stretching an images so that it fills the screen. The top half of this figure (FIG. 3(a)) shows an un-stretched 16:9 image on a 4:3 screen using letterboxing to fill the top and bottom, whereas the bottom half (FIG. 3(b)) places the same 16:9 image into the same 4:3 screen but stretches the image vertically to fill the whole screen and thus avoid the use of letterboxing (while slightly distorting the image).

A further alternative that has been used involves manually “panning-and-scanning” a window—of the shape of the target screen—over the original image and to then use those cropped images to fill the target screen. This pan-and-scan approach helped improve awkward shots where important parts of an image, perhaps a “two-shot” (i.e. capturing in profile the faces of two people sitting across a table and talking to each other) were cropped too tightly. While re-sizing image for a different screen-size or shape may result in losing part or all of one of the faces, panning-and-scanning may allow both to be shown at different times but may make it hard to show simultaneously a line delivered by one character and a reaction from another.

Screens now appear not just on televisions and at cinemas but also on smart phones, tablets, phablets and PCs, of course. These screens do not slavishly adhere to 16:9 aspect ratio (and even some televisions can be found with a 21:9 aspect ratio). Even if they do adopt a common aspect-ratio, phones in particular are likely under some circumstances to be viewed in “portrait” mode forcing even more severe letterboxing.

FIG. 4 shows a 16:9 landscape image shown in a 16:9 screen where the screen is held in the “portrait” orientation.

In consequence the use of pillars and letterboxing to view images on “off format” screens is commonplace. Screens may also offer functions that allow all pixels on the screen to be lit but at the expense of seeing all the image.

To ensure that important information in the image is visible there is the concept of the “safe area”—essentially a defined central area of the screen which it is presumed will (or at least should) always be visible regardless of the screen on which the image is presented. In traditional (non-OBB) content-provision, a content producer or provider can ensure that any graphic elements added to a primary element (e.g. a leader-board or scorecard superimposed over video images of a sporting event) are located in a portion of the display that prevents them from obscuring the central portion of the primary element, and will generally not do so even if the images are stretched, narrowed, cropped or otherwise adjusted for screens of different sizes.

A peculiarity of the above approaches is that all image components of the screen (video, graphics etc.) are on a single layer and all are scaled or cropped using a single function.

Referring to various prior disclosures, a web-page entitled “HTML Responsive Web Design” available at https://www.w3schools.com/html/html responsive.asp from w3schools.com provides an online tutorial about techniques for using Hypertext Markup Language (HTML) and Cascading Style Sheets (CSS) to resize, hide, shrink or enlarge a website automatically to make it look good on different types of device (desktops, tablets and phones).

A paper from a presentation in the IBC2018 conference entitled “2-IMMERSE: A platform for production, delivery and orchestration of Distributed Media Applications” available at https://www.ibc.org/manage/2-immerse-a-platform-for-production-and-more-3316.article (dated 27 Sep. 2018) describes an overview of the architecture of an evaluated multi-screen experience based on MotoGP sports content, which was developed using an object-based broadcasting approach.

A document entitled “2-IMMERSE Deliverable D2.4 (Distributed Media Application Platform-Description of Second Release” dated 11 Jan. 2018, available at https://2immerse.eu/wp-content/uploads/2018/01/d2.4-distributed-media-application-platform-description-of-second-release-0.31.final .pdf (Section 6.2 in particular) describes 2-IMMERSE Distributed Media Application Platform, Multi-Screen Experience Components and Production Tools that have been developed for the project's second service prototype, “Watching MotoGP at Home”, and discusses the project's technical achievements along with details of the current status of the platform, components and key features.

A video entitled “2-IMMERSE MotoGP Service Prototype Video” dated 17 Jan. 2018, available online at https://www.youtube.com/watch?v=FZlhrnGzC4l, introduces the 2-IMMERSE MotoGP service prototype and shows its features in action. In particular, the commentary refers to the ability to adapt and scale the layout of on-screen graphics.

A paper entitled: “Workflow Support for Live Object-Based Broadcasting” by Jack Jansen, Pablo Cesar & Dick Bulterman (DocEng '18, Aug. 28-31, 2018, Halifax, NS, Canada) available at https://ir.cwi.nl/pub/28131/28131.pdf examines the document aspects of object-based broadcasting. It presents a model and implementation of a dynamic system for supporting object-based broadcasting in the context of a motor sport application. It defines a multimedia document format that supports dynamic modifications during playback, which allows editing decisions by the producer to be activated by agents at the receiving end of the content.

Referring now to prior patent documents, U.S. Pat. No. 9,569,501 (“Chedeau et al”) relates to the optimisation of electronic layouts for media content. In one embodiment, a method is described which involves accessing N electronic media-content items and a plurality of media-content templates, where each of the media-content templates includes a pre-determined number of surface areas for a pre-determined number of media-content items. The method includes scoring, based on one or more features, for each of one or more of the media-content templates, the placement of X of the electronic media-content items in the media-content template, where X equals the lesser of N and the pre-determined number of surface areas of the media-content template. The method includes selecting one of the media-content templates with a highest score and providing the X electronic media-content items in the selected media-content template for display to a user.

While the option of OBB clearly offers potential advantages in terms of user experience and otherwise, the provision of media content using OBB techniques when a presentation may be rendered and displayed on user devices of different possible shapes and sizes, to users with different requirements and preferences, where each user's presentation of a particular programme may include a different set of media objects, and with other possible variable factors, introduces challenges in relation to how the media content should best be provided. While some users may be capable of and/or may enjoy setting up and/or making their own adjustments to their presentations, which may be done on a programme-by-programme basis, by setting up general preferences, or otherwise, others may not be capable of doing so or may not wish to do so, or may simply prefer for their presentation to be provided in a form that does not require setting-up or adjustment. Without knowledge of the different contexts in which the presentation is to be viewed by different users, it is a challenge to provide OBB media content for different users in such a way as to maintain the benefits offered by OBB while satisfying the likely requirements/desires of the different users.

### SUMMARY OF THE INVENTION

According to a first aspect of the invention, there is provided a computer implemented method for processing media content to be rendered as a presentation for a user at a set of one or more media devices in an arrangement at a point in time, the presentation being based on layout rules defining suitability and configuration of media objects for rendering as part of the presentation, the arrangement and one or more user-associated characteristics and/or attributes constituting a context for the presentation, wherein the presentation is formed of selected media objects from a set of media objects, and the context having associated one or more constraints, each constraint defining a property of the context affecting the rendering of at least a subset of the selected media objects, the method comprising the steps of:
configuring, for each media object in the set, a characteristic of the media object, the configured characteristic satisfying a utility condition based on a measure of utility of the media object in the context at the point in time, the measure of utility being evaluated in respect of the constraints of the context; and
identifying the selected media objects from the set based on the measure of utility associated with each selected media object and the layout rules.

The set of media objects nay comprise media objects providing one or more of video content, audio content, text content, and graphics content. Other types of media objects are also possible.

Media objects providing video content may provide content such as live-streamed video, replayed video (sporting action-replays etc.), computer-generated video content (e.g. special-effects), on-screen signing (e.g. for the deaf or hard-of-hearing), picture-in-picture inserts, studio-rendered virtual reality overlays, etc.

Media objects providing audio content may provide content such as music, speech (from characters shown in video objects or otherwise), sound-effects, background sounds, commentary (on a sporting event, for example), etc.

Media objects providing text content may provide content such as subtitles, information about video, audio or other content, information about a sporting event being broadcast (scores, scorecards or leader-boards, for example), etc.

Media objects providing graphics content may provide content such as diagrams, sports team formations or illustrations of tactics, etc.

According to preferred embodiments, the layout rules defining suitability and configuration of media objects for rendering as part of the presentation may comprise rules determining whether, when, where and how respective media objects are to be rendered. These may be based on requirements/preferences of (for example) a provider, producer or director of the overall content, and/or of one or more users/viewers of the content.

According to preferred embodiments, the characteristics of media objects may comprise one or more of size, screen-position, colour-scheme, transparency (i.e. whether and how easily objects in front of other objects allow those behind to be seen) and layering-order (i.e. which visual objects appear to be in front of or behind others) of object-based graphics.

According to preferred embodiments, the set of one or more media devices in an arrangement at a particular point in time may comprise more than one media device in an arrangement. The devices may comprise a large-screen object such as a television or computer-screen and a hand-held and/or small-screen device such as a tablet or smart-phone, for example, or other such “two-screen” or multi-screen arrangements. In such embodiments, the characteristics of media objects may comprise the media device from the set on which the media object should appear, thereby allowing users/viewers to ensure that certain objects (e.g. objects carrying statistics, or live-chat, for example) appear on a hand/held device, for example.

According to preferred embodiments, the step of identifying the selected media objects from the set may be performed by adding media objects to a list of media objects to be rendered based on utility values evaluated in respect thereof until it is determined that applicable layout rules cannot be complied with. Such a technique may be used to ensure that the objects deemed to be most important (based on a combination of applicable factors which may include any applicable user-preferences provided by a user) are prioritised.

Alternatively or additionally, the step of identifying the selected media objects from the set may be performed by identifying media objects such that the sum of the utility values evaluated in respect thereof is maximised without breaching applicable layout rules. Such a technique may be used to ensure that an overall “best compromise” determined, which may be appropriate if a particular media object that would be highly-desirable if selected would then result in several other slightly-less-desirable objects being missed or de-emphasised.

According to preferred embodiments, the steps of configuring and identifying may be at least partly performed before communication of the selected media objects to one or more client media devices. A complete or part-complete presentation may then be communicated from a provider or an intermediate entity to one or more users' media devices.

According to alternative embodiments, the steps of configuring and identifying may be at least partly performed after communication of the set of media objects to one or more client media devices. Such embodiments may be useful in allowing locally-expressed or locally-available user-preferences and/or requirements to be more easily incorporated into the decision-making process.

According to preferred embodiments, the method may further comprise rendering the selected media objects from the set. Such rendering of the selected media objects may be performed after communication of the selected media objects to one or more client media devices. In embodiments where the steps of configuring and identifying are performed before communication of the selected media objects to one or more client media devices, such rendering may be performed before communication of the selected media objects to client media devices.

According to preferred embodiments, the method may further comprise providing the selected media objects from the set as a presentation via one or more client media devices.

According to a second aspect of the invention, there is provided apparatus for processing media content to be rendered as a presentation for a user at a set of one or more media devices in an arrangement at a point in time, the presentation being based on layout rules defining suitability and configuration of media objects for rendering as part of the presentation, the arrangement and one or more user-associated characteristics and/or attributes constituting a context for the presentation, wherein the presentation is formed of selected media objects from a set of media objects, and the context having associated one or more constraints, each constraint defining a property of the context affecting the rendering of at least a subset of the selected media objects, the apparatus comprising a computer system including a processor and memory storing computer program code for performing the steps of the method according to the first aspect.

According to a third aspect of the invention, there is provided a computer program element comprising computer program code to, when loaded into a computer system and executed thereon, cause the computer to perform the steps of a method according to the first aspect.

The various options and preferred embodiments referred to above in relation to the first aspect are also applicable in relation to the second and third aspects.

### BRIEF DESCRIPTION OF THE DRAWINGS

A preferred embodiment of the present invention will now be described with reference to the appended drawings, in which:

FIGS. 1 to 4 illustrate techniques by which the scale of content may be adapted for presentation on different screens;

FIG. 5 is a block diagram of a computer system suitable for the operation of embodiments of the present invention;

FIGS. 6(a) and 6(b) illustrate entities that may be involved in performing methods according to embodiments of the invention according to two possible scenarios;

FIG. 7 illustrates steps that may be performed in a method according to preferred embodiments of the invention; and

FIG. 8 is a graph illustrating how utility values may be calculated for a presentation value such as the rendered size of an on-screen graphic for different values of a constraint based on the quality of a user's sight.

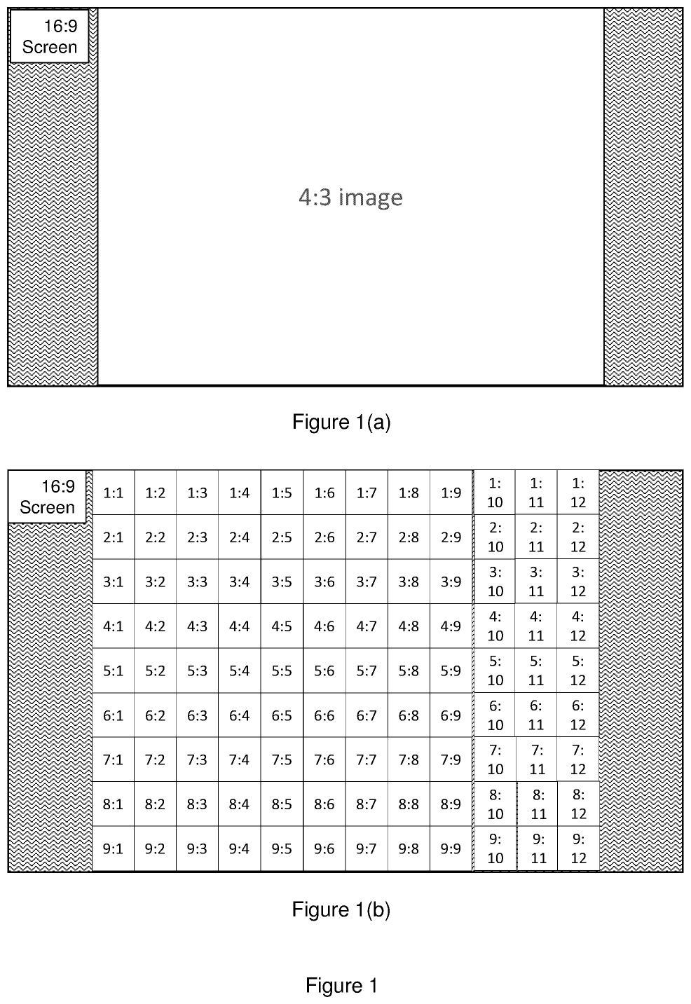

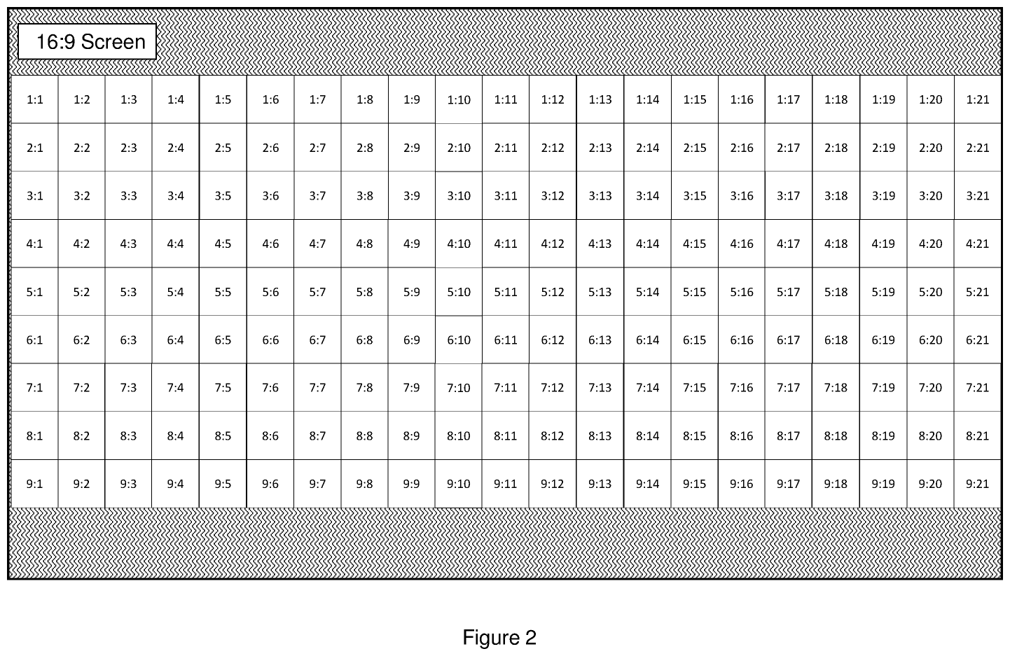

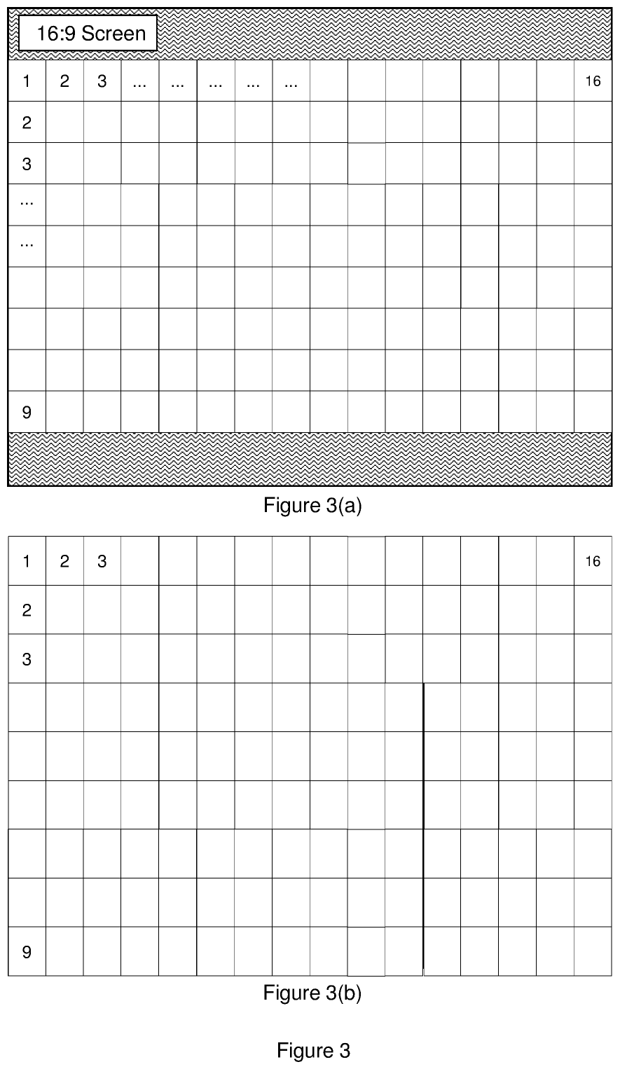

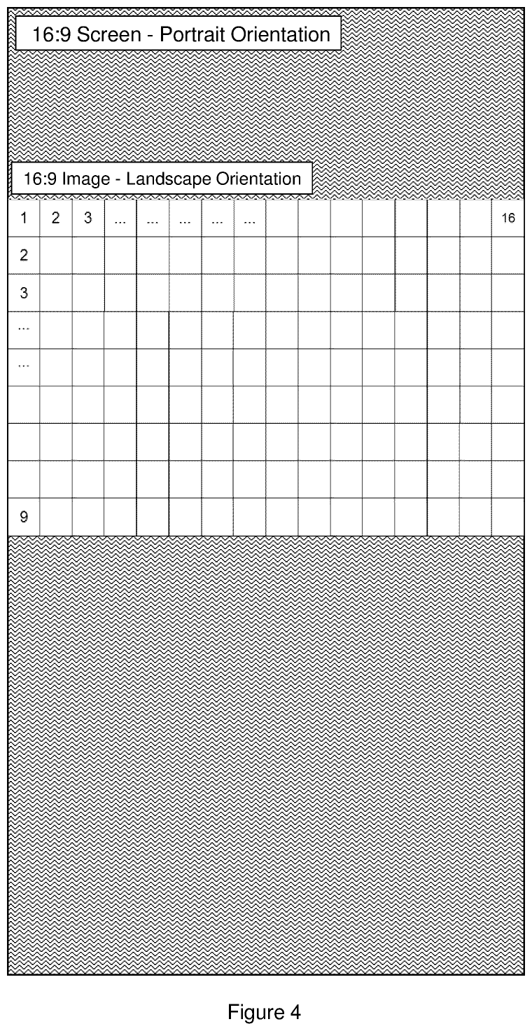

### DESCRIPTION OF PREFERRED EMBODIMENTS OF THE INVENTION

With reference to the accompanying figures, methods and apparatus according to embodiments will be described.

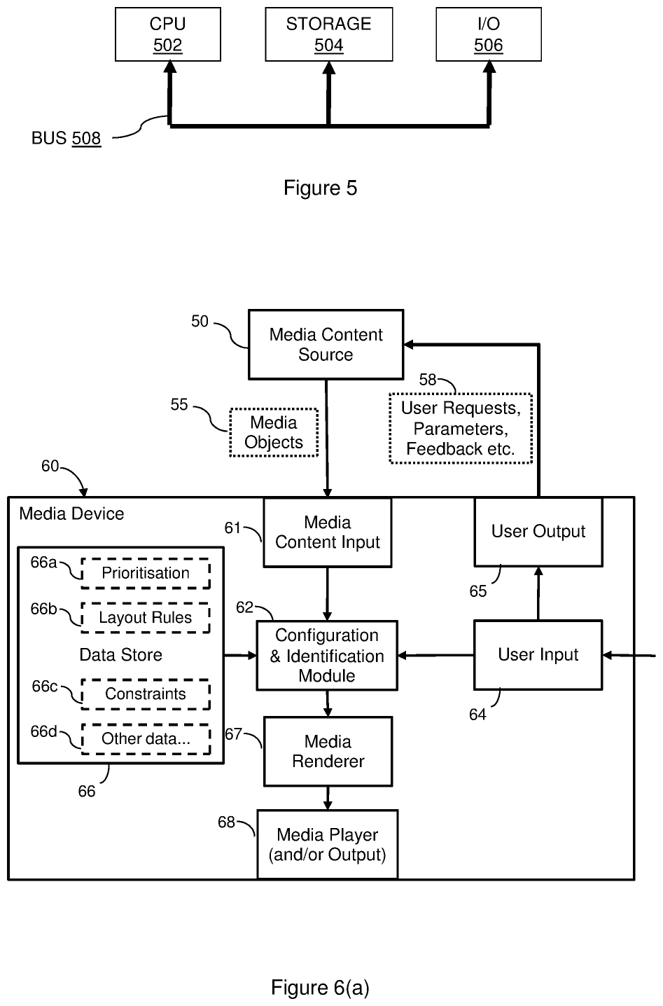

Firstly, FIG. 5 is a block diagram of a computer system suitable for the operation of embodiments of the present invention. A central processor unit (CPU) 502 is communicatively connected to a data store 504 and an input/output (I/O) interface 506 via a data bus 508. The data store 504 can be any read/write storage device or combination of devices such as a random access memory (RAM) or a non-volatile storage device, and can be used for storing executable and/or non-executable data. Examples of non-volatile storage devices include disk or tape storage devices. The I/O interface 506 is an interface to devices for the input or output of data, or for both input and output of data. Examples of I/O devices connectable to I/O interface 506 include a keyboard, a mouse, a display (such as a monitor) and a network connection.

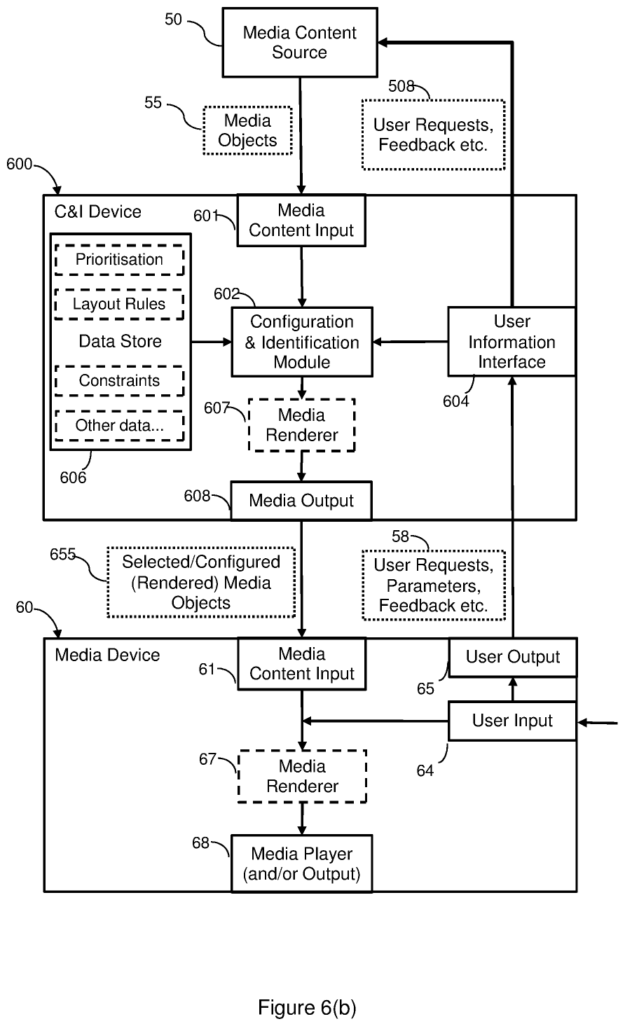

Referring to FIG. 6(a), this illustrates entities that may be involved in performing a method according to an embodiment of the invention, in a scenario where the configuration and identification of media objects for a presentation for a particular user is performed at that user's media device.

In the present embodiment, a media device 60 (which may be a television, a smart phone, a tablet, a phablet (a phone/tablet hybrid), a PC, or another such device via which a consumer or user may receive, watch and/or otherwise consume media content) requests and receives media content in the form of media objects 55 from a media content source 50, receiving the media objects via a media content input interface 61. The media content may be for a programme such as an object-based broadcast of a sporting event or other such programme, a film, an interactive event, an online computer game, or otherwise. The received media content is passed to a Configuration and Identification module 62, the functions of which will be explained in detail later.

The Configuration and Identification module 62 is in communication with a user input interface 64 via which information may be received about user preferences and/or requirements. This information may be provided actively by a user, or may be derived from monitoring the user (or users) and/or the environment in which the user and/or media device is located (obtaining information about who the (primary) user/viewer is, how many viewers there are, how large the room is, how far viewers are from a screen, etc.). The user input interface 64 may also be used to receive other information from the user, including information 58 to be provided from a user output interface 65 of the media device 60 to the media content source 50 or elsewhere. This information 58 may simply include information such as requests for specific media content, but in some embodiments (in particular, embodiments in which some or all of the decision-making concerning proposed layouts is taken at the media content source 50 or at another such device from which the media content may be provided to the user's media device) it may also include information such as parameters relating to the user's display device(s) (e.g. size, shape, resolution, technical capabilities or features) or the user(s) (whether they are visually-impaired, hard-of-hearing, have specific interests in particular characters or aspects of the types of media content they might request, etc.) feedback on received media content and/or other user preferences and/or requirements.

The Configuration and Identification module 62 is also in communication with a Data Store 66 in which may be stored data relating to matters such as layout rules 66b, constraints 66c and prioritisation factors 66a (which will be discussed below), and possibly other types of data 66d.

Based on information received via the user input interface 64 and information retrieved from the Data Store 66, the Configuration and Identification module 62 follows a process which will be described in detail below in order to form a presentation of selected media objects from those received via the media content input interface 61, the selected media objects being configured based on information received and/or retrieved by the Configuration and Identification module 62 so as to meet or optimise objective criteria indicative of whether the presentation, when rendered and displayed to the user (or users) in question, will meet or optimise objective user experience criteria.

The presentation, with its selected media objects each configured in order to meet or optimise the objective criteria in question, can then be provided to a media renderer 67 for rendering, then displayed or otherwise played as an output for the user(s) by a media player 68, which itself may be linked to a single display device or a set of display devices (e.g. to allow the presentation to be split between multiple devices, such as a television and a tablet).

The rendering and displaying/playing of the presentation may be performed by modules of the media device 60 itself (as shown in FIG. 6(a)), or either or both functions may be performed by external media-rendering and playing/displaying devices using the presentation provided as an output from a media output 68 (shown as an alternative within the media player 68). In a further alternative, the presentation as determined by the Configuration and Identification module 62 may be provided to the user as a suggested or default presentation which the user may simply accept (without needing to go through any specific configuration steps), or may adjust further based on their own preferences or their own satisfaction with the automatically-provided presentation that has been personalised for them as a personal “default” presentation.

Referring now to FIG. 6(b), this illustrates entities that may be involved in performing a method according to an alternative embodiment of the invention, in a scenario where the configuration and identification of media objects for a presentation for a particular user is performed prior to provision of the media content in question to the user's media device.

In this embodiment, a Configuration & Identification (C&I) Device 600 remote from the user's media device 60 (and possibly co-located with or as a part of the media content source 50) performs at least some of the functions performed in the above embodiment by the media device 60, in particular those performed by the Configuration and Identification module 62 in the above embodiment in respect of media content from the media content source 50 before providing media content comprising already-selected-and-configured (and possibly rendered) media content to the media device 60. Reference numerals corresponding to those used in FIG. 6(a) will be used for entities with corresponding functionality. The functionality of others-and the overall functionality of the alternative embodiment will be explained below.

In the alternative embodiment illustrated by FIG. 6(b), the C&I device 60 again requests and receives media content in the form of media objects 55 from the media content source 50, receiving the media objects via a media content input interface 601. The received media content is passed to a Configuration and Identification module 602, the functions of which correspond generally to those of the Configuration and Identification module 602 in the above embodiment, which will be explained in detail later.

The Configuration and Identification module 602 is in communication with a user information input interface 604 via which information 58 may be received from the user's media device, This may include information such as requests for specific media content (which may be passed on to the media content source 50), and may also include information such as parameters relating to the user's display device(s) (e.g. size, shape, resolution, technical capabilities or features) or relating to the user(s) (whether they are visually-impaired, hard-of-hearing, have specific interests in particular characters or aspects of the types of media content they might request, etc.), feedback on received media content and/or other user preferences and/or requirements. As before, this information may be provided actively by a user, or may be derived from monitoring the user (or users) and/or the environment in which the user and/or media device is located.

The Configuration and Identification module 602 is also in communication with a Data Store 606 in which may be stored data relating to matters such as layout rules, constraints and prioritisation factors (which will be discussed below) and possibly other types of data.

Based on information received via the user information interface 604 and information retrieved from the Data Store 606, the Configuration and Identification module 602 follows a process which will be described in detail below in order to form a presentation of selected media objects from those received via the media content input interface 601, the selected media objects being configured based on information received and/or retrieved by the Configuration and Identification module 602 so as to meet or optimise objective criteria indicative of whether the presentation, when rendered and displayed to the user in question, will meet or optimise objective user experience criteria.

The presentation, with its selected media objects each configured in order to meet or optimise the objective criteria in question, can then be provided to a media renderer 607 for rendering, then provided via a media output 608 to the user's media device 60 to be displayed or otherwise played for the user. Alternatively, the presentation, with its selected media objects each configured in order to meet or optimise the objective criteria in question, can then be provided not-yet-rendered via media output 608 to the user's media device 60 to be rendered by a media rendered 67 in user's media device 60 before being displayed or otherwise played for the user. Either way, it will be appreciated that the user's media device 60 receives already-selected-and-configured (possibly rendered) media content from the C&I device 600.

The above embodiments thus involve processes being performed which may manipulate the scale and/or layout (and possibly other characteristics, such as colour-schemes, transparency and/or layering-order) of object-based graphics presented on a set of one or more screens (i.e. TV screens or other devices), enabling those graphics to be always visible and legible (insofar as this is possible given the applicable constraints associated with the context in question) irrespective of the screen size(s) and shape(s) of the device(s) in question and of the position(s) of the viewer(s) relative to the device(s), for example. Where a complex arrangement of multiple graphics objects is required, it enables the presentation to be prioritised so that graphics which are essential for interaction, or which are most important for the viewer(s) in question (e.g. visually-impaired users, the hard-of-hearing, viewers with specific interests in particular characters or aspects of the content in question, etc.) are given greater prominence in terms of scale and/or layout and/or other characteristics.

A key advantage of preferred embodiments is that they may determine objective values of individual media components on a continuous basis throughout a TV programme or other media content experience, doing this by considering the relationship between attributes which control its presentation and the constraints of the available device(s) and user(s). This approach creates a ‘utility value’ for each component at any moment in time, which may then be used to select a set of media objects (i.e. as components of the presentation) and attributes thereof which—insofar as it is possible—both:
a) Meet a pre-determined threshold for individual objective Quality of Experience (QoE); and
b) Meet pre-determined requirements for overall presentation, in accordance with a broadcaster's/author's style guide, for example.

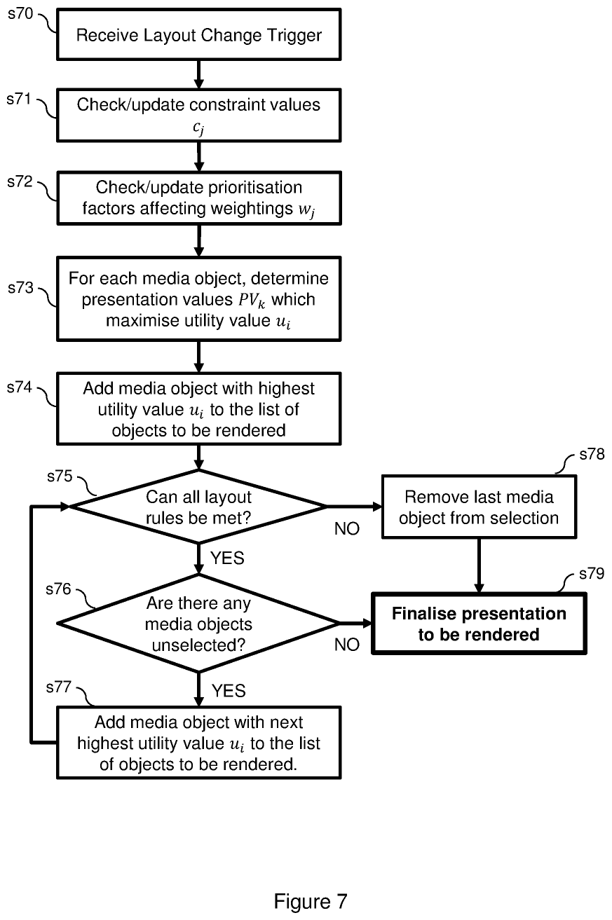

With reference also to FIG. 7, a method according to a preferred embodiment will be described. This builds upon the Layout Service as defined and implemented within the EU-funded collaborative project 2-IMMERSE (www.2immerse.eu) and subsequently released as open source code (under the Apache 2 licence) within the 2-IMMERSE GitHub organisation (https://github.com/2-IMMERSE/layout-service).

As defined in 2-IMMERSE deliverable D2.2 (Platform-component interface specifications) and at https://2immerse.eu/wiki/layout/:
The layout service is responsible for managing and optimising the presentation of a set of DMApp Components [media objects] across a set of participating devices (i.e. a context).
The resources that the layout service exposes through its API are:
   context—one or more connected devices collaborating together to present a media experience
   DMApp (Distributed Media Application)—a set of software components that can be flexibly distributed across a number of participating multi-screen devices. A DMApp runs within a context.
   component—a DMApp software component
For a running DMApp (comprising a set of media objects/DMApp Components that varies over time); it's authored layout requirements, user preferences, and the set of participating devices in the context (and their capabilities), the layout service will determine an optimum layout of components for that configuration. It may be that the layout cannot accommodate presentation of all available components concurrently.
The service instance maintains a model of the participating devices (the context) and their capabilities e.g. video: screen size, resolution, colour depth, audio: number of channels, interaction: touch etc.
The layout requirements will specify for each media object/DMApp component: layout constraints such as min/max size, audio capability, interaction support, and whether the user can over-ride these constraints. Some of these constraints may be expressed relative to other components (priority, position, etc.).
The layout model that the layout service will adopt is to be determined, but a range of options exist from very simple (a single component being shown full screen with a simple chooser), through to non-overlapping grid based arrangements, overlapping models such as Picture-in-picture, through to a full 3D composition of arbitrary shaped components.

Specifically, the present embodiment may be regarded as changing the concept of applying fixed constraints to a media object as part of the authoring process by providing a technique which systematically expresses and evaluates a complex and dynamic relationship between a set of constraints and the ‘presentation variables’ which define how a media object is presented on a device.

In relation to this embodiment, the following terms are defined:

A “presentation” is the rendering-for one or more users-of a personalised, object-based experience on one or more devices which offer audio and/or video playback capabilities, and the possibility of user interaction (e.g. mouse, keyboard, touch, voice). A presentation is the result of a process which determines, on a continuous basis, the media content of an object-based experience and how it should be presented; it is the finished article which is seen/consumed by the user or users.

A “context” is the name given to describe the set of devices which are available to the one or more users in question at any moment in time for rendering a personalised, object-based presentation for the one or more users (generally, viewers, but one or more may just be listeners, for example) in question. The “context” is thus constituted by the arrangement of one or media devices on which a presentation may be rendered (and may actually be displayed/played) in combination with one or more user-associated characteristics and/or attributes, examples of which are given below. As will be appreciated, the context may thus change on an ongoing or continuous basis as devices may become available or be removed at any time, and may also change if one or more of the user-associated characteristics and/or attributes changes. As will be explained, examples of user-associated characteristics and/or attributes include the identity or number of users/viewers, their position with respect to (or distance from) a display device, and stored issues about the specific user(s)/viewer(s).

The “arrangement” and one or more such user-associated characteristics and/or attributes of the one or more users in question together constitute a “context” for the presentation in question.

A “media object” is a component which is rendered on a device within a “context” as part of a “presentation”. Media objects include audio streams, video streams, text content and on-screen graphics.

A “presentation variable” or “attribute”, PV, is an attribute of a media object which defines one aspect of its presentation on a device. Presentation variables may include the physical size at which graphics will be rendered on a screen; whether or not the presentation should include an audio description, subtitles, or a signer; how a zoomed image should be centered on the screen; colours chosen for graphics; volume level, etc.

A “presentational constraint”, c, is a property of the “context” in which the “presentation” is being delivered, and may be a continuous or categorical variable. Constraints may include:
A categorical variable indicating the quality of a user's sight, e.g. {unimpaired, partially sighted, blind}.
Continuous variables defining parameters such as the size, aspect ratio and pixel resolution of a device.
A categorical variable indicating a functional capability of the device(s), such as the type(s) of interaction supported on the device(s), e.g. {none, single-point-touch, multi-point-touch, pushbutton-remote}, etc.

The concept of “Utility” is defined as an objective measure of how well a user is able to understand and interact with an experience. A “utility value”, u, is a value which indicates the contribution to the overall “utility” of the “context” that a media object makes when subject to particular value (or values) of the “presentation variable” (or variables).

A “prioritisation factor”, w, is a numerical scale factor which can be used to assign a weighting to a specific “constraint” when used as part of a “utility value” calculation.

The utility value, [symbol] _{i,j,k}, for a combination of media object i, constraint cⱼ and presentation variable PVₖ can be expressed as:

[symbol]

_{i,j,k}=ƒ(cⱼ, PVₖ)×wⱼ

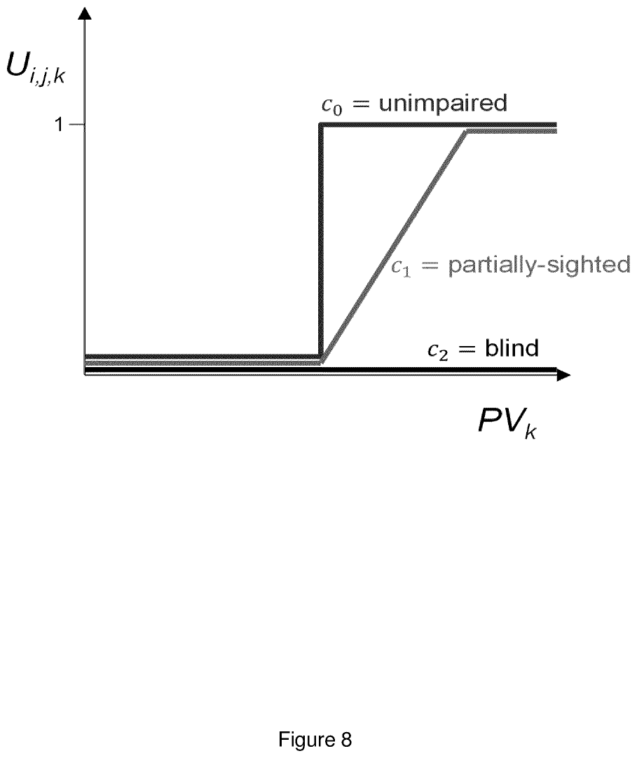

The function ƒ(cⱼ, PVₖ) may be a continuous function or a combination of discrete functions. For example, in the graph shown in FIG. 8, three discrete functions show how the utility value could be calculated for a presentation value such as the rendered size of an on-screen graphic for different values of a constraint based on the quality of a user's sight. For a user with unimpaired vision, the stepped function c₀ indicates that utility is zero for values of an attribute up to a certain threshold, but that utility is at its maximum level for values of the attribute above that threshold. For a partially-sighted user, the sloped function c₁ indicates that utility is zero for values of an attribute up to a certain threshold, then increases up to its maximum level as values of the attribute increase. For a blind user, the function c₂ indicates that utility is zero irrespective of the value of the attribute in question (e.g. irrespective of the size used for a graphic object, it will not benefit the user in question).

These functions could be determined on a per-object basis, or for groups of objects, and enable production decisions to be incorporated, such as the minimum (and/or maximum) acceptable size for an on-screen graphic, based on the context in question.

The above allows the utility [symbol] ᵢ for media object i to be calculated according to the function:

$${i}_{} = {\sum }_{j , k} f ( {c}_{j} , {PV}_{k} ) \times {w}_{j}$$

The “total utility” U for a set of media objects in a specific context is therefore:

$$U = {\sum }_{i} {u}_{i}$$

It is important to note that this utility calculation is dependent on the time at which it is made, and the total utility U could change when media objects are added or removed from the presentation, and may also change when devices are added or removed from the context.

A “layout model” (building on the definition above) is a set of rules which are evaluated on all media objects to be rendered within a “context”. The layout model restricts how a set of media objects and their chosen presentation variables can be assembled to create a presentation in accordance with a broadcaster's/author's style guide. For example, rules could be used in order to:
define regions within which certain media object types can be displayed
define the minimum space between on-screen graphics media objects (thus preventing occlusions)
define a maximum number of objects to be displayed simultaneously (to avoid complexity)

On this basis, the process shown in FIG. 7 can be used to create and maintain an optimal object-based presentation while accommodating a set of dynamic constraints.

As indicated in the descriptions of embodiments provided earlier with reference to FIG. 6(a) and FIG. 6(b), the processing of media content to be rendered as a presentation for a user according to preferred embodiments may be performed by a module 62 of (or associated with) the user's media device 60, or by a device such as the C&I device 600 shown in FIG. 6(b) (which may be co-located with the media content source 50 or located elsewhere), with the selected and configured media objects then being rendered before or after being provided to the user's media device 60. The process illustrated in FIG. 7 thus indicates the fundamental steps that may be involved in processing media content to be rendered as a presentation for a user according to a preferred embodiment, whether those steps are performed by a module 62 of or associated with the user's media device 60 or by a device such as the C&I device 600 shown in FIG. 6(b), and does not include additional steps that may happen in different ways before and/or after the steps shown in FIG. 7 partly to avoid overly complicating the flow-chart and partly because the nature of those additional steps depends in general on the overall type of embodiment. Such additional steps (e.g. preliminary steps such as the initial requesting and initial provision of media content in the form of media objects; and subsequent steps such as the displaying of content once a set of media objects has been selected and configured for a user) have thus been discussed earlier in association with the figures illustrating the specific exemplary embodiments. FIG. 7 thus starts at a point where the entity configured to perform a method according to an embodiment has received media content in the form of media objects which, in the absence of processing according to the process illustrated, would generally simply be rendered for display in a default layout or presentation for all users as suggested by a content provider or producer for example, or be rendered for display in a layout or presentation that each user may first need to configure from scratch.

The process illustrated starts by receipt (at step s70 ) of a layout change trigger. This may be a request from a user to incorporate one or more additional media objects into the user's presentation (or an indication that the user wishes to remove one or more media objects from the user's existing presentation), or an indication that the user has started to use or is about to start to use one or more additional screens (e.g. a tablet device to supplement what is being displayed on a television) and wishes to shift one or more media objects (e.g. a leader-board, or a camera-feed following a particular player in a sporting event) to the additional screen (or wishes to stop using one or more additional screens, etc.). Alternatively or additionally, a layout change trigger may come from the broadcaster requesting that one or more additional media objects is/are incorporated into the user's presentation. This may be because a broadcaster wishes to add a new lower-third graphic to indicate a goal score, for example, with this displacing an existing user-requested graphic due to layout rules or prioritisation. Another option is that the layout change trigger may be based on an indication of context such as an indication that at least one user is hard-of-hearing (so needs a media object showing subtitles) or visually impaired (so needs media objects showing text to be larger or to be presented using a more easily-read colour-scheme), for example, or may be a determination that a user has moved nearer to or further away from a display and may therefore benefit from a presentation in which a primary media object or a text-based media object takes up more or less of the overall screen area. Other types of layout change trigger are also possible.

At step s71, the entity performing the process checks and if appropriate updates the constraint values cⱼ in respect of the current context for the presentation, where the context for the presentation comprises the current arrangement of one or more media devices in association with the current user (or users) viewing the presentation. The constraints may thus relate to the number of displays being used, together with their sizes, shapes and capabilities, or characteristics of the user(s), for example. Each constraint cⱼ defines a property of the context which may affect the manner in which at least a subset of the selected media objects should be rendered to best satisfy objective quality of experience criteria.

At step s72, the entity performing the process may check and if appropriate update one or more prioritisation factors based on user preferences or otherwise which may affect weightings wⱼ to be used in respect of specific constraints. The prioritisation factors may thus relate to factors that the user has indicated are deemed important (such as a preference for a leader-board to be shown at a specific location in a primary screen and to cover less than a sixteenth of the area of the screen, or for a leader-board to be shown on a tablet (i.e. a “second screen”), or for a video feed concentrating on a particular player to be displayed in a particular off-centre portion of the primary screen, for example). The “prioritisation factors”, w, are numerical scale factor which can be used to assign a weighting to a specific “constraint” when used as part of the “utility value” calculation described below.

At step s73, the entity performing the process determines, for each media object (i.e. those already or potentially included in the presentation), presentation values PVₖ which maximise a utility value [symbol] ᵢ for the media object in question. As explained earlier, “utility” is an objective measure of how well a user is able to understand and interact with an experience, and the “utility value”, u, for a media object is a value which indicates the contribution to the overall “utility” of the “context” that a media object makes when subject to a particular value (or particular values) of the presentation variable or variables. The result is a list of utility values for the respective media objects in the current context, allowing the media objects to be ranked in relation to the current context. Data such as presentation variables, utility values, lists of media objects, etc. may be transient and may be held (temporarily) in the Configuration & Identification Module 62.

It should be noted that in some embodiments, the “utility value”, u, may be evaluated using a utility function dependent on just one presentation variable and/or just one constraint. In other embodiments, it may be evaluated using a utility function dependent on plurality of presentation variables and/or a plurality of constraints, however.

At step s74, the entity performing the process determines which media object has the highest utility value (in the current context) then adds this media object to the list of media objects potentially to be rendered. (The list may initially have one or more default media objects with default presentation values, or may start with no media objects and be built up from there.)

At step s75, it is determined with reference to the stored layout rules whether it is still possible to meet the applicable layout rules with the list of selected media objects as it stands. As explained earlier, layout rules may restrict how a set of media objects and their chosen presentation variables can be assembled to create a presentation in accordance with a broadcaster's/author's style guide, or in accordance with stated user preferences. They may define regions within which certain media object types can or cannot be displayed, or define the minimum space between on-screen graphics media objects (thus preventing occlusions), or define a maximum number of objects to be displayed simultaneously (to avoid complexity). Other types of layout rules are also possible.

If it is still possible to meet the applicable layout rules with the additional object added to the list, the process proceeds to step s76, at which it is determined whether other media objects are available for possible selection. If so, at step s77, the media object with the next-highest utility value (in the current context) is identified and added to the list of media objects potentially to be rendered, and the process returns to step s75 at which it is again determined with reference to the stored layout rules whether it is still possible to meet the applicable layout rules.

If it is found at step s75 that the addition of a further media object to the list of media objects potentially to be rendered makes it impossible to meet the applicable layout rules, the process proceeds to step s78, at which the last media object to have been added to the list is removed. The process then proceeds to step s79 at which the presentation is finalised, ready to be rendered. It may then be rendered, making it ready to be displayed, or may be provided to an entity which is to render it and make it ready to be displayed.

Correspondingly, if it is found at step s76 that there are no other media objects available for possible selection, the process proceeds to step s79 at which the presentation is finalised, ready to be rendered. As set out in the previous paragraph, it may then be rendered, making it ready to be displayed, or may be provided to an entity which is to render it and make it ready to be displayed.

According to the above process, a presentation is thus prepared that includes as many media objects as is possible (with each configured to have its maximum utility in the current context) without making it impossible to satisfy the applicable layout rules, optionally taking account also of specific user preferences (if any have been provided). An alternative to this is to offer the determined presentation as an initial suggested presentation to the user (based on the current context) then allow the user to request changes to the suggested presentation by then specifying user preferences (the provision of which may then be treated as layout change triggers or as direct commands), by directly requesting changes to that, or otherwise.

As indicated earlier, additional type of data to include within the Data Store (66 in FIG. 6(a), 606 in FIG. 6(b). In some embodiments, a history of media object lists, presentational variables and utility values may be stored, allowing such “historical” data to be used as part of the decision-making process in order to ‘smooth’ changes in the user-experience and avoid possible instability (i.e. several changes at once, or presentations oscillating between a few states). Alternatively, such issues may be dealt with by appropriate design of utility functions and layout rules.

Other processes may be used in order to prepare a suggested presentation for the user in the current context, in accordance with other embodiments. Instead of the process shown, in which additional objects are added one-by-one to a list of media objects potentially to be rendered until it becomes impossible to meet applicable layout rules, an alternative optimisation-based approach may be used to select the set of objects that in total has the highest sum of utility values (without contravening the applicable layout rules). This may lead to a presentation being selected and configured that doesn't include the media object that would have the highest individual utility value if this then allows several other media objects to be included that it would not be possible to include alongside the media object having the highest individual utility value. In some cases, this may be a preferable process to that shown in FIG. 7.

In preferred embodiments, the utility function or functions would generally be chosen in order to ensure consistency between the utility function(s) and the layout model rules to ensure that the above process (or similar processes) cannot lead to undesirable situations such as those in which no media objects are selected for presentation. Other techniques may be used to ensure that there is always at least one media object selected. A default media object may initially be included in the set of selected media objects, with rules ensuring that if the default media object is to be removed from the list due to performance of the process, this can only happen if the total number of selected media objects would still be at least one, for example.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilises the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

It will be understood by those skilled in the art that, although the present invention has been described in relation to the above described example embodiments, the invention is not limited thereto and that there are many possible variations and modifications which fall within the scope of the invention.

The scope of the invention may include other novel features or combinations of features disclosed herein. The applicant hereby gives notice that new claims may be formulated to such features or combinations of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method for processing media content to be rendered as a presentation for a user at a set of one or more media devices in an arrangement at a point in time, the presentation being based on layout rules defining suitability and configuration of media objects for rendering as part of the presentation, the arrangement and one or more user-associated characteristics and/or attributes constituting a context for the presentation, wherein the presentation is formed of selected media objects from a set of media objects, and the context having associated one or more constraints, each constraint defining a property of the context affecting the rendering of at least a subset of the selected media objects, the method comprising the steps of:
configuring, for each media object in the set, a characteristic of the media object, the configured characteristic satisfying a utility condition based on a measure of utility of the media object in the context at the point in time, the measure of utility being evaluated in respect of the constraints of the context; and
identifying the selected media objects from the set based on the measure of utility associated with each selected media object and the layout rules.

2. A method according to claim 1 wherein the set of media objects comprises media objects providing one or more of video content, audio content, text content, and graphics content.

3. A method according to claim 1 wherein the layout rules defining suitability and configuration of media objects for rendering as part of the presentation comprise rules determining whether, when, where and how respective media objects are to be rendered.

4. A method according to claim 1, wherein the characteristics of media objects comprise one or more of size, screen-position, colour-scheme, transparency and layering-order of object-based graphics.

5. A method according to claim 1 wherein the set of one or more media devices in an arrangement at a particular point in time comprises more than one media device in an arrangement.

6. A method according to claim 5 wherein the characteristics of media objects comprise a particular media device from the set on which the media object should appear in the arrangement.

7. A method according to claim 1 wherein the step of identifying the selected media objects from the set is performed by adding media objects to a list of media objects to be rendered based on utility values evaluated in respect thereof until it is determined that applicable layout rules cannot be complied with.

8. A method according to claim 1 wherein the step of identifying the selected media objects from the set is performed by identifying media objects such that the sum of the utility values evaluated in respect thereof is maximised without breaching applicable layout rules.

9. A method according to claim 1 wherein the steps of configuring and identifying are performed before communication of the selected media objects to one or more client media devices.

10. A method according to claim 1 wherein the steps of configuring and identifying are performed after communication of the set of media objects to one or more client media devices.

11. A method according to claim 1 wherein the method further comprises rendering the selected media objects from the set.

12. A method according to claim 11 wherein the rendering of the selected media objects is performed after communication of the selected media objects to one or more client media devices.

13. A method according to claim 1 wherein the method further comprises providing the selected media objects from the set as a presentation via one or more client media devices.

14. Apparatus for processing media content to be rendered as a presentation for a user at a set of one or more media devices in an arrangement at a point in time, the presentation being based on layout rules defining suitability and configuration of media objects for rendering as part of the presentation, the arrangement and one or more user-associated characteristics and/or attributes constituting a context for the presentation, wherein the presentation is formed of selected media objects from a set of media objects, and the context having associated one or more constraints, each constraint defining a property of the context affecting the rendering of at least a subset of the selected media objects, the apparatus comprising a computer system including a processor and memory storing computer program code for performing the steps of the method of claim 1.

15. A computer program element comprising computer program code to, when loaded into a computer system and executed thereon, cause the computer to perform the steps of a method as claimed in claim 1.
